(19) United States
(12) Patent Application Publication
(10) Pub. No.: US 2009/0303832 A1
(43) Pub. Date: Dec. 10, 2009

(54) Agitator

(75) Inventors: Mikko Hirvensalo, Karhula (FI); Olavi Koskinen, Halikko (FI); Heikki Manninen, Vilppula (FI)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Pumpen AG, Winterthur (CH)

(21) Appl. No.: 11/886,346

(22) PCT Filed: Mar. 8, 2006
(86) PCT No.: PCT/CH06/00141

§ 371 Date: Jul. 22, 2009

(30) Foreign Application Priority Data
Mar. 17, 2005 (FI) 20050284

(51) Int. Cl. B01F 13/08; B01F 7/00

(52) U.S. Cl. 366/282

(57) ABSTRACT

The present invention relates to an agitator. The present invention especially relates to an agitator, which may be attached to the bottom, wall or cover of a mixing vessel. The agitator in accordance with the present invention is especially applicable to purposes where a relatively large and slowly rotating agitator is required. Thus, for example, agitators used in dilution vessels and the like of wood processing industry come into question. A characterizing feature of an agitator in accordance with the present invention is that the drive unit of the agitator comprises a disc (48) attached to an end of an agitator shaft (42) opposite to an agitator means (20), and a casing (50) surrounding said disc in such a way that the disc (48) is provided with permanent magnets operating together with coils (56) arranged to at least one wall (52, 54) of the casing (50) surrounding the disc (48) or in connection therewith forming a permanent magnet motor.

The present invention relates to an agitator. The present invention especially relates to an agitator, which may be attached to a bottom, wall or cover of a mixing vessel. The agitator in accordance with the present invention is especially applicable to purposes where a relatively large and slowly rotating agitator is required, but the space to be used is limited. Thus, for example, agitators used in dilution vessels, storage towers and the like of wood processing industry come into question.

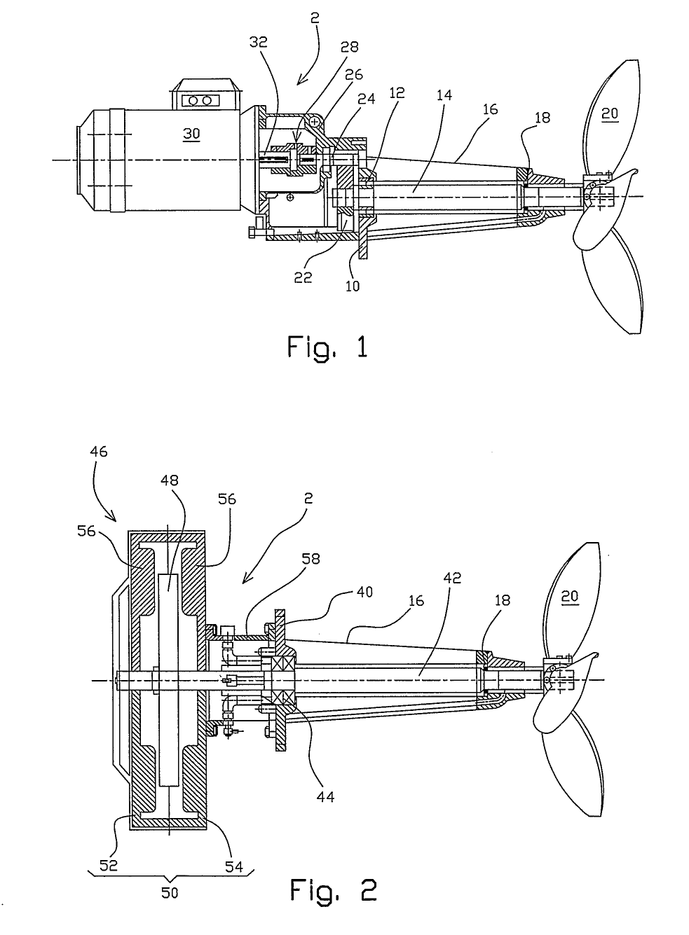

There are previously known agitators, such as the one disclosed in FIG. 1 or in U.S. Pat. No. 5,040,899 in which the agitator is formed of an entity composed in connection with a mounting flange, by means of which the agitator is mounted on where it is used. In the structure of FIG. 1, there is a bearing arranged within the agitator flange for the agitator shaft. Similarly, a support, in the case of FIG. 1 a cone, extending to the inside of the vessel is mounted at its one end on the flange, and at the opposite end of said support a second bearing is arranged for the agitator shaft. In other words, the agitator shaft is supported as a whole to the mounting flange. An agitator means is mounted on the end of the agitator shaft inside the vessel, which means is most often a conventional propeller. A gear wheel is attached to the other end of the agitator shaft immediately outside the mounting flange, said gear wheel forming one part of the speed reduction gear of the agitator. The other part of the speed reduction gear is arranged to be in contact with said gear wheel so that its drive shaft is mounted with bearings preferably, but not necessarily, at its one end on the above-mentioned mounting flange and close to its other end on a body member arranged in connection with the mounting flange. Said drive shaft is provided at its outer end with a coupling, one part of which is mounted on the shaft of a conventional drive motor. The drive motor again is naturally located, in the embodiment of the drawing, directly behind the coupling, outside thereof, as seen from the vessel.

In some cases, the above disclosed speed reduction gear carried out by means of gear wheels in the agitator drive is replaced with belt drive.

A disadvantage connected to the above-described embodiment is the relatively large space it requires in radial direction outside the vessel. This may sometimes set considerable limitations to the location of both the vessel and the agitators to be assembled in connection with vessel.

Other disadvantages are the various factors depending on the mechanical structure of the agitator drive, for example:
parts liable to wearing, such as bearings, gear wheels or belts,
need for maintenance of the drive unit, such as oil changes, relubrications or belt tensionings,
control and monitoring of the operation and condition,
additional loading caused by the drive unit to the agitator, such as the axial load because of the gear forces or the radial load because of the belt tensioning,
liability to damages due to the structure of the drive unit is relatively high.

The present invention aims at eliminating at least some of the disadvantages of the agitators in accordance with the prior art by means of a new maintenance-free drive unit allowing the mounting of the drive unit directly on the agitator shaft without a separate speed reduction gear or like.

Other features typical of an agitator in accordance with the invention become evident from the accompanying patent claims.

Advantages of the arrangement in accordance with the invention are, for example, the following:
Drive unit does not include parts, such as bearings, gear wheels or belts, liable to wearing due to power transmission.
Drive unit does not require maintenance, such as oil changes, relubrication or belt tensioning.
Drive unit does not require control or monitoring.
The risk of damage of the drive unit is almost non-existent.
No additional load, such as axial load of the gear forces or radial load because of the belt tensioning, is caused to the agitator.
Drive unit protects the agitator shaft and the agitator means against the damages due to overload, because the torque curve of the apparatus is horizontal.

The agitator in accordance with the present invention is described more in detail with reference to the accompanying drawings, in which

FIG. 1 schematically illustrates an agitator in accordance with prior art; and

FIG. 2 schematically illustrates an agitator in accordance with the present invention.

FIG. 1 discloses a conventional structural solution for an agitator in accordance with prior art, in which agitator 2 is formed of an entity constructed in connection with a mounting flange 10, by which the agitator is mounted on where it is used. In the structure of FIG. 1, a bearing 12 is arranged within the agitator flange 10 for the agitator shaft 14. Similarly, a support, which in this embodiment is a cone 16, extending to the inside of the vessel (not shown, but would be located to the right from the flange 10 in the drawing) is mounted at its one end on the flange 10. A second bearing 18 is arranged at the opposite end of said cone for the agitator shaft 14. In other words, the agitator shaft 14 is supported as a whole to the mounting flange 10, at its one end directly and at its other end via the support 16. An agitator means 20 is mounted on the end of the agitator shaft 14 inside the vessel, which means is most often a conventional propeller with multiple blades. A gear wheel 22 is attached immediately outside the mounting flange 10 (seen from the vessel), to one end of the agitator shaft 14, which gear wheel forms one part of the speed reduction gear of the agitator 2. The other part of the speed reduction gear is arranged to be in contact with said gear wheel 22 so that its drive shaft 24 is mounted with bearings preferably, but not necessarily, at one of its one end on the above-mentioned mounting flange 10 and close to its other end to a body member 26 arranged in connection with the mounting flange 10. Said drive shaft 24 is connected by means of a conventional coupling 28 to the shaft 32 of a conventional drive motor 30. The drive motor 30 again is naturally located, in the embodiment of the drawing, directly behind the coupling 28, outside thereof as seen from the vessel.

It does not become clear from the embodiment of FIG. 1, but because the speed reduction gear is mechanical, it requires lubrication, which means that the speed reduction gear has to be positioned into a sealed, closed space in the agitator body 26. In addition to the sealings, said space in the body also requires means for monitoring the amount of oil, which can be, for example, a dip stick, a control window for the liquid level or like arrangement.

Another way of modifying the relatively small torque generated by an electric motor to greater torque more suitable for the agitator, whereby at the same time the high rotational speed of the electric motor turns to a lower rotational speed of the agitator, is to use belt drive, but it requires monitoring of the condition of the belt, too, as well as a protective cover in view of possible belt damages. Both drive types subject the shaft of the drive itself as well as that of the agitator to both radial and axial loads.

For example, the above-mentioned problems have been solved in an agitator in accordance with FIG. 2 by arranging a new kind of permanent magnet motor as the agitator drive. It is also called a magnetic flux motor. The agitator illustrated in FIG. 2 partly comprises, mainly as of its parts inside the vessel, the same components as the agitator in accordance with the prior art. The same reference numbers are used in connection with said parts. In other words, the agitator in accordance with the invention is attached to the vessel by means of a mounting flange 40, from which a support 16 for the agitator, said support being of conical shape or some other suitable shape, extends inside the vessel. The bearing arrangement 18 of a shaft 42 and at least the sealing required by the bearing arrangement are positioned at the opposite end of said support 16. The actual agitator means 20 is naturally mounted on the agitator shaft 42.

The agitator shaft 42 is also mounted with a bearing 44 on the mounting flange 40. As an exception to the prior art solution, the agitator shaft 42 extends farther from the wall, bottom or cover of the vessel so that spaced from the mounting flange 40 is mounted a radial disc 48 on the shaft 42, preferably, but not necessarily, substantially on one end thereof, which disc 48 is provided with permanent magnets within equal circumferential distances from each other. Said disc 48 and the end of the shaft are surrounded by a casing 50, the radial walls 52, 54 of which or in connection therewith are provided with coils 56 substantially facing the permanent magnets of the disc. Said coils 56 may be found, however, only on one side of the disc 48, in other words only on one side wall of the casing 50, but preferably the casing 50 is provided with coils 56 on both sides of the disc 48. In other words, said disc 48 forms a rotor 48 of the permanent magnet motor 46 and said casing 50 with the coils 56 the stator of said motor. In the embodiment of the drawing, the stator 50 is attached to the mounting flange 40 of the agitator by means of an intermediary sleeve 58. The drive unit 46 thus operates with the permanent magnet motor principle in such a way that the torque for the shaft 42 is generated electrically through the coils 56 of the stator 50 to the rotor 48 provided with permanent magnets. The operation of the permanent magnet motor is controlled by a frequence converter, by which both the rotational speed of the motor and the torque it generates may be controlled reliably and accurately.

The above-described embodiment enables the mounting of the agitator drive very close to the wall of the vessel or like position, to which the agitator flange is attached. In fact, the only thing requiring some distance from the vessel wall or the like is the lubrication of the bearing 44, which is, however, preferably arranged to be performed from outside the vessel, in other words from between the mounting flange 40 of the agitator and the stator 50 of the permanent magnet motor 46. However, by constructing the bearing housing in the flange 40 such that the bearing is positioned to some extent closer to the agitator means 20, the lubrication of the bearing can be carried out through channels arranged in the flange itself, whereby the stator of the permanent magnet motor can be mounted directly on the mounting flange of the agitator. In some cases, it is even possible to integrate the agitator flange 40 with the casing 50, more closely with the sidewall 54 of the casing 50 facing the flange 40.

As can be seen from the above description, a new kind of an agitator is provided, which is considerably simpler, more reliable and less space consuming than the previous agitators. It is, however, to be understood that the invention is not limited to the disclosed embodiments, but is intended to cover various combinations and/or modifications of its features and other applications within the scope of the invention as defined in the appended claims.

1. An agitator, comprising at least a mounting flange (40), by means of which said agitator is attached to a vessel or a tower; an agitator shaft (42), mounted with bearings (44, 18) both on said mounting flange (40) and a support (16) extending from said mounting flange (40) into said vessel or tower; an agitator means (20) mounted on the support-side end of the agitator shaft and a drive unit for the agitator, characterized in that the drive unit comprises a disc (48) attached to an end of the agitator shaft (42) opposite to said agitator means (20), and a casing (50) surrounding said disc in such a way that the disc (48) is provided with permanent magnets cooperating with coils (56) arranged to at least one wall (52, 54) of the casing (50) surrounding the disc (48) or in connection therewith forming a permanent magnet motor.

2. Agitator in accordance with claim 1, characterized in that said coils (56) are arranged to a substantially radial side wall (52, 54) of the casing (50) surrounding said disc (48).

3. Agitator in accordance with claim 1, characterized in that said coils (56) are arranged to both of the substantially radial side walls (52, 54) of the casing (50) surrounding the disc (48).

4. Agitator in accordance with claim 1, characterized in that said permanent magnets are arranged on the disc (48) at even circumferential distances from each other.

5. Agitator in accordance with claim 1, characterized in that the casing (50) is attached by means of its side wall (54) to the agitator flange (40).

6. Agitator in accordance with claim 1, characterized in that the casing (50) is attached to the agitator flange (40) by means of an intermediary sleeve (52).

7. Agitator in accordance with claim 1, characterized in that the casing (50) is integrated with the agitator flange (40).

8. Agitator in accordance with claim 1, characterized in that the agitator flange (40) is provided with means for lubricating the bearing (44) arranged in connection with the flange (40).

9. Agitator in accordance with claim 1, characterized in that it is mounted via its flange (40) on the bottom, wall or cover of the vessel or tower.
